(19) United States
(12) Patent Application Publication
(10) Pub. No.: US 2013/0190652 A1
(43) Pub. Date: Jul. 25, 2013

(54) SAMPLE RETENTION DEVICE

(71) Applicants: Juliet Carter, Leamington Spa (GB); Robert Van Schie, Leamington Spa (GB)

(72) Inventors: Juliet Carter, Leamington Spa (GB); Robert Van Schie, Leamington Spa (GB)

(73) Assignee: NAMMONIC HOLDING LIMITED, Leamington Spa, Warwickshire (GB)

(21) Appl. No.: 13/878,854

(22) PCT Filed: Sep. 28, 2011
(86) PCT No.: PCT/GB11/51830

§ 371 Date: Apr. 11, 2013

(30) Foreign Application Priority Data
Oct. 12, 2010 (GB) 1017185.8

(51) Int. Cl. B01L 3/00

(52) U.S. Cl. CPC B01L 3/505
USPC 600/573; 422/547

(57) ABSTRACT

A flexible container (10) for capturing and or storing saliva, blood or any other body fluid, or biological sample of contained DNA and or other nucleic acid for immediate or later analysis. This bag holds one or more strips (22) assembled from purpose prepared absorbent matrix. A desiccant-containing pouch may be bonded to the interior of the storage device. When the flexible container is manipulated to the open position, the matrix, which is bonded to the interior, becomes exposed. A specimen can then be applied to this matrix. When opened, the bag stands up on its own, allowing the matrix to dry. Upon closure, the air-dried specimen-containing matrix withdraws inside the bag. This flexible container provides in one package, without the need for direct handling of the matrix, a specimen holding means, and protective storage within a substantially airtight, light-proof, and moisture-proof environment for a considerable period of time.

This invention relates to a sample retention device, more particularly a storage container for capturing, packaging and possibly long-term storing means for saliva, blood or any other body fluid, or biological sample of contained DNA and or other nucleic acid material.

A known method of sample storage is to place a purpose prepared storage matrix with a desiccant-containing pouch in a substantially airtight, light-proof, moisture-proof sealable container. However, the storage matrix and the pouch require handling to place them inside the container. There is a serious risk of unwanted contamination and mismatching samples by incorrect identification in the handling and labelling process.

According to the present invention there is provided a sample retention device according to claim 1.

The design of the device permits capturing saliva, blood or any other body fluid, or biological sample of contained DNA and or other nucleic acid, free of unwanted contamination or the need to touch specimen samples. The device also provides the means for labelling, holding and preserving the specimen samples for an indefinite period without the risk of lamentable degradation.

Further, the invention provides in one simple assembly, a replacement for a series of costly and complicated items for capturing and storing saliva, blood or any other body fluid, or biological sample of contained DNA and or other nucleic acid, for immediate or likely future analysis.

Thus the DNA and or possibly other nucleic acid sample, which have been preserved and maintained in a substantially damp-proof, light-proof and air-proof container, possibly for a long period of time, is available in its original form for examination and testing. Labelling and/or imagery which is integrated into the exterior of the bag itself may maintain the integrity of the data applied, avoiding the risk of labels becoming detached, misplaced or replaced.

Two embodiments of the invention will now be described referring to the accompanying drawings:

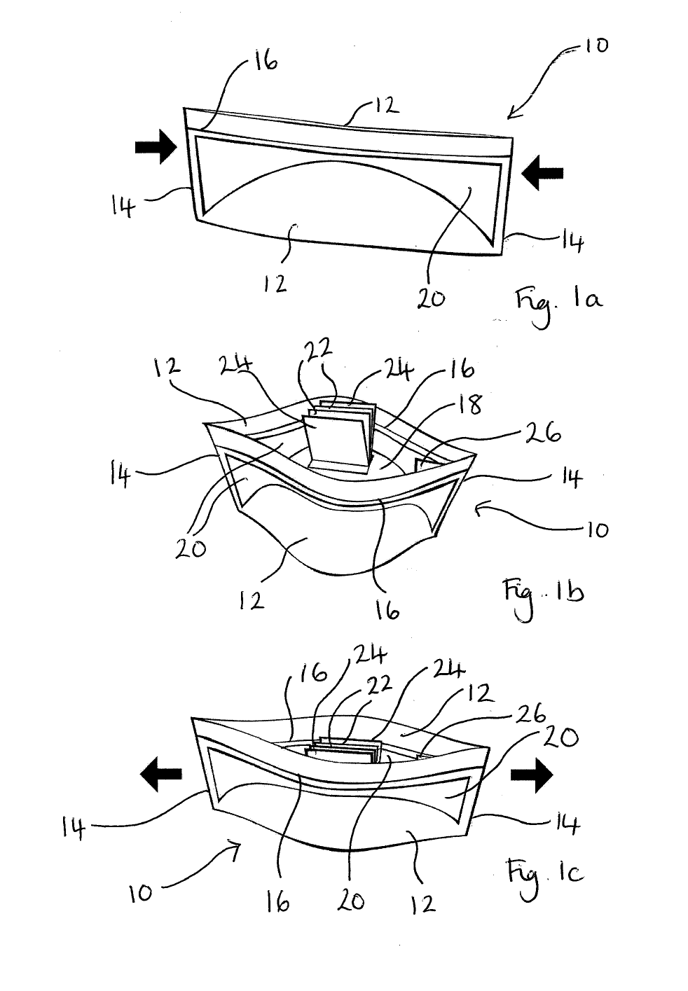

FIG. 1 shows the sample retention device of the first embodiment a) in a closed state; b) in an open state in which the retaining element extends through the opening; and c) during closing;

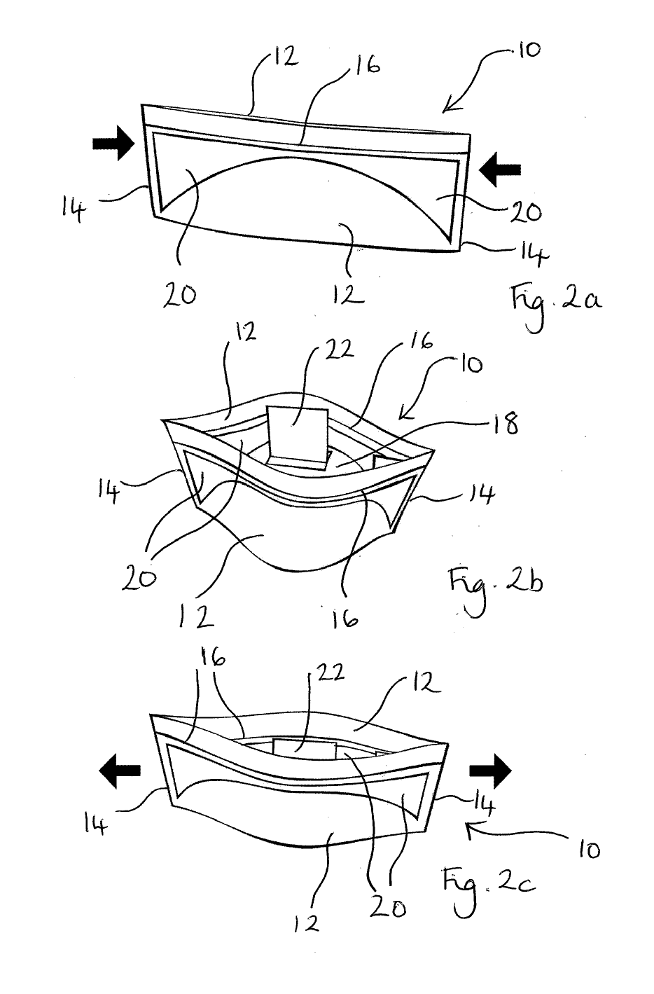

FIG. 2 shows the sample retention device of the second embodiment, which comprises only one sheet of purpose prepared matrix, a) in a closed state; b) in an open state in which the retaining element extends through the opening; and c) during closing;

FIG. 1a shows the device or container 10 of the first embodiment in a first condition i.e. a closed state. The container is in the form of a substantially rectangular bag formed of airtight, light-proof, and moisture-proof plastics sheet material. The container 10 comprises a body formed from two opposed sides 12, formed of planar sheets. The sides 12 are joined directly to each other at each end 14. The outer layer of the container may be markable without the use of separate labels. The external faces of the container may be provided with suitable printed instructions for preparing, handling and storing the sample, and integrated labelling means for the positive dating and identification of the sample contained within the container.

Opening and closure means 16 are near the top of the sides 12. The closure means 16 are in the form of matching complementary resealable engaging sets of ribs. An internal gusset, support or base 18, is formed from a sheet. Edge portions of the sheet are bonded to the inner surfaces of the sides 12 in the area 20. The gusset 18 is able to fold flat between the sides 12, so that the container can be flat in the closed state. In the closed state, the retaining element is surrounded by the body such that it is enclosed within the device. The retaining element does not extend through the opening. The bag therefore protects the matrix before the bag is opened. The bag is manipulated to the second condition or open position by disengaging the complementary resealable set of closure ribs 16, holding the bag by the connected pairs of ends 14 of the sides 12, and pushing in the direction indicated by the arrows.

FIG. 1b shows the container in an open position. Having disengaged the complementary resealable set of closure ribs 16, and pushed the ends 14 of the sides 12 of the flexible bag 10 inwards towards each other, as indicated by the arrows in Figure la, the bag has become open. The walls 12 of the bag move away from each other in the regions intermediate the ends 14 by means of the gusset 18. The bottom edges of the sides 12 of the container 10 move apart in a region intermediate their ends and so are separated in this intermediate region in the opening process, which allows the container to be placed down, and stand up freely on its own, by resting on the lower edges of the sides 12.

Two retaining elements comprising two strips of absorbent or purpose prepared preservative absorbent paper or other solid material matrix 22 are attached to the gusset 18. In the closed state of the container 10, the matrix 22 does not extend through the opening. On opening the container 10, the gusset 18 in the bottom of the bag is vertically pushed up causing the matrices 22 to extend through the opening. Two strips 24 of protective shield material are arranged either side of the matrices 22. Each matrix 22, close to one end, is adhered or welded to the gusset on the inside of the container, on or close to the fold of the gusset. In the open container state, the matrices 22 are accessible for the application of saliva, blood, any other body fluid, or biological sample of contained DNA and or other nucleic acid to it. This may be done, for example, by placing a swab with a sample between the matrices 22, and pressing the sheets 24 together.

The two strips of absorbent or purpose prepared absorbent paper or other solid material 22 and the two strips of protective shield material 24 stand erect on the support 18 and attached at their bases to the support 18, surrounded by air, in the open state. The matrices are subsequently air-dried.

The strips of absorbent or purpose prepared preservative absorbent paper or other solid material 22 may be perforated and or strips of it may be easily detached, may be differentiated along its length, and may have a functional active part of the strips being at one end, while the bodies of the strips act as carriers for the active parts of the strip.

The flexible container may provide space for the inclusion of a desiccant-containing pouch 26 which is directly bonded to the interior of the bag 10.

The container can be closed by reverse manipulation as shown in FIG. 1c. The sides of the container are held and pulled away from each other as indicated by the direction of the arrows. The two strips of absorbent or purpose prepared preservative absorbent paper or other solid material and two strips of protective shield material are withdrawn into the interior of the container, beyond and inside the line of the closure ribs, thus drawing the air-dried active tips to a position within the bag to be stored for likely future analysis. The gusset is returned to its normal position, the closure ribs are then engaged by pressing them together, thereby sealing the container. The two strips of absorbent or purpose prepared absorbent preservative paper or other solid material strips and the two strips of protective shield material are thus stored within the borders of the container. The container maintains the substantially flat, rectangular shape of its borders for ease of storage.

Thus the specimen sample is held within the container, maintaining it in a shielded and generally moisture-free, airtight and dark environment after application. It is not necessary to touch the active part of the absorbent or purpose prepared absorbent paper or other solid material strip, and therefore it can remain predominantly free of unwanted contamination.

FIG. 2a shows the container of the second embodiment in a closed position. This container is similar to that of the first embodiment and so the same reference numerals will be used for similar features, and only the differences will be described.

Instead of two strips of two matrices 22 of absorbent or purpose prepared preservative absorbent paper or other solid material there is only one matrix or retaining element 22.

Near to one end, the matrix 22 is adhered or welded to the gusset 18 on the inside of the container in the same manner as the matrices (or protective sheets) of the first embodiment.

The single strip of absorbent or purpose prepared absorbent paper or other solid material 22 stands erect, supported by and attached at its base within the container, surrounded by air. As in the first embodiment, the matrix 22 can be made to extend at least partially through the opening of the container by squeezing the ends 14 of the sides 12 together.

The bag is opened/closed and the matrix extended in the same manner as in the first embodiment.

In the first embodiment, the material 22, instead of being fastened directly to points within the interior of the container, may be fastened to protective shield material 24, which is bonded to the base of the container.

In both embodiments, the retaining element or elements do not extend through the opening in the closed state, but it should be apparent to the skilled man that they could do, as long as, in the open state, the retaining element or elements are in a more accessible position than in the closed state.

Although in the above embodiments closure ribs 16 are provided, they need not be. For example, for use at a hospital, clinic or some public central point, heat-sealing facilities may be available, the container may be provided with the opening welded shut, and the matrix or matrices 22 contained within the container. The end can be cut off and the bag manipulated and the active tip deployed as previously described; then the sample is collected and air-dried, the active tip is withdrawn in the bag and the mouth is once again heat sealed or welded shut.

In the first embodiment, a separate swab is used to collect the sample, the sample then being transferred to the matrices 22. However, a swab could be integrated into the container. For example, a swab could be attached to the edge of a matrix, such that it can be folded in between the matrices 22 to transfer the sample. The swab could be planar like the matrix 22.

It should be apparent to the skilled man the a range of sizes and dimensions could be used, but in a preferred embodiment, the gusset is 10 cm long, and 6 cm wide, and the concave depth of the join of the gusset to each side is 3 cm at its maximum. Alternatively preferable ratios of the length of the support to its concave depth, i.e. the concave depth of its join with the sides, are 2.0 to 4.5, more preferably 2.5 to 4.0, and most preferably 3.0 to 3.5, and preferable ratios of the length of the support to its width are 0.5 to 3.0, more preferably 1.0 to 2.5, and most preferably 1.4 to 1.9. The length and width are the absolute dimensions of the gusset, irrespective of its arrangement, i.e. they are the dimensions of the gusset if it was laid out flat.

1. A sample retention device for retaining biological samples, the device comprising:
a retaining element, for holding a biological sample,
a body attached to the retaining element,
the body defining an opening and at least partially surrounding the retaining element in a first condition and being deformable from the first condition to a second condition,
wherein the device is arranged such that upon deformation of the body from the first condition to the second condition, the retaining element moves towards the opening to a more accessible position.

2. The sample retention device according to claim 1, in which the first condition is a substantially closed condition and the second condition is an open condition.

3. The sample retention device according to claim 1, wherein the body is biased towards the first condition.

4. The sample retention device according to claim 1, wherein the device is operable between the first and second condition by squeezing opposed portions of the body towards each other.

5. The sample retention device according to claim 4, wherein the body includes a retaining element support to which the retaining element in connected, the support being connected at opposed ends to the opposed portions of the body, such that when the opposed portions of the body are squeezed towards each other, the portion of the support to which the retaining element is connected moves to a more accessible position.

6. The sample retention device according to claim 5, wherein, where the body defines an opening, the support moves towards the opening.

7. The sample retention device according to claim 1, wherein the body comprises two opposed sides walls, each side wall being connected at opposed ends to the other side wall to form two pairs of ends, the pairs of ends being the opposed portions of the body.

8. The sample retention device according to claim 7, wherein, where the body defines an opening, the opening is defined at least partially by the two opposed side walls,

9. The sample retention device according to claim 7, wherein in the first condition, the two opposed sides are substantially parallel, and, on operation from the first condition to the second condition, the sides move apart in a region intermediate the pairs of connected ends.

10. The sample retention device according to claim 1, wherein the retaining element does not extend through the opening when the device is in the first condition.

11. The sample retention device according to claim 1, wherein, in the first condition, the device is arranged such that it can be substantially flat.

12. The sample retention device according to claim 7, wherein each side wall is directly connected at each pair of ends to the other side wall.

13. The sample retention device according to claim 7, wherein the support is attached to the inner faces of the side walls.

14. The sample retention device according to claim 13, wherein the support is attached to the inner faces of the side walls to form an hermetic closure.

15. The sample retention device according to claim 14, wherein the support is formed from a sheet, the portions of the sheet not forming the support being parallel to the side walls and bonded to the inner faces of the side walls.

16. The sample retention device according to claim 5, wherein, when the device is in the first condition, and the body defines an opening, the profile of the support between the opposed body portions to which it is connected is concave towards the opening.

17. The sample retention device according to claim 16, wherein the ratio of the length of the support to its concave depth when the device is 3.0 to 3.5.

18. The sample retention device according to claim 5, wherein the ratio of the length of the support to its width is 1.0 to 1.5.

19. The sample retention device according to claim 16, wherein, where the body defines an opening, the retaining element extends from the portion of the concave support closest to the opening.

20. The sample retention device according to claim 1, wherein the retaining element comprises at least a portion which is absorbent for retaining a sample.

21. The sample retention device according to claim 1, wherein the retaining element is planar.

22. The sample retention device according to claim 21, wherein, where the body comprises two opposed sides, the retaining element is connected to the support such that it is substantially parallel with the sides when the device is in a closed state.

23. The sample retention device according to claim 21, wherein the device comprises a pair of retaining elements, both elements being planar, and arranged with their faces opposing each other.

24. The sample retention device according to claim 23, wherein the device further comprises two protective sheets, one arranged on each side of the pair of retaining elements.

25. The sample retention device according to claim 22, wherein the or each retaining element is connected to the support via a protective sheet.

26. The sample retention device according to claim 23, , wherein the container further includes a swab element, for obtaining samples, the swab element being foldable to lie between the retaining elements.

27. The sample retention device according to claim 26, wherein the swab is planar and extends from the retaining element closest in a substantially coplanar manner with the retaining element.

28. The sample retention device according to claim 7, wherein, where the body defines an opening, each side wall includes a sealing rib, the sealing ribs being arranged to cooperate to form a seal to close the opening.

29. The sample retention device according to claim 1, wherein a desiccant-containing pouch is attached to the device so that it lies within the device.

30. (canceled)
